(19) United States
(12) Patent Application Publication
(10) Pub. No.: US 2004/0015702 A1
(43) Pub. Date: Jan. 22, 2004

(54) User login delegation

(76) Inventors: Dwayne Mercredi, Sherwood Park (CA); Rod Frey, Edmonton (CA)

Correspondence Address: WOOD, HERRON & EVANS, LLP, 2700 CAREW TOWER, 441 VINE STREET, CINCINNATI, OH, 45202, US

(21) Appl. No.: 10/398,356

(22) PCT Filed: Mar. 1, 2002
(86) PCT No.: PCT/US02/06536

(51) Int. Cl. H04L 9/00

(52) U.S. Cl. 713/182

(57) ABSTRACT

An apparatus 10, method and program product 42 logs a delegate user into an account of a principal user on behalf of the principal in response to authentication code, such as biometric data, correlated to the delegate user. Actions taken by the delegate while within the account of the principal may be recorded for evaluation and accountability considerations. Delegate user(s) privileged to access the account of the principal are added and deleted to a profile 44 as necessary to facilitate controlled sharing of resources.

### FIELD OF THE INVENTION

The present invention relates generally to identity authentication technologies, and more particularly, to using authentication technologies and techniques to control access to electronic data.

### BACKGROUND OF THE INVENTION

Considerations regarding the safeguarding of computer resources have become ubiquitous throughout industry, government and private channels. Typical security measures require a user to sign on (i.e., log in) to a computer or network by providing a user ID and an authentication code, such as a password, identification card smart card token device, or biometric data (fingerprint, retinal scan, voice, or the like, If the authentication code given at the time of log-on is verified to that which was previously stored for that user ID, then the person seeking to sign on is given access to the computer or network, or portion thereof, as is customary. An area of concern arises, however, where a user (referred to herein as a “principal user”) wishes to allow someone else to sign on as the delegate of the principal user. For example, a busy executive may want one or more assistants to actually sign on to the system as the executive. This type of delegated access presents some unique concerns.

For example, in the password environment, a principal user may simply tell the delegate the principal user's password which thus allows the delegate to sign on as the principal user. Such password sharing is fraught with problems, not the least of which is the security risk created by giving out passwords. Similarly, in the identification card or token environment, a principal user may simply loan the principal user's identification card to the delegate which thus allows the delegate to sign on as the principal user. Such identification card sharing is fraught with problems, not the least of which is the security risk created by loaning identification cards. On the other hand, biometric systems generally preclude the ability for a principal user to allow a delegate to access the system on behalf of the principal user. The unique nature of biometric data simply does not lend itself to “sharing”. Moreover, when a delegate accesses the system as if he were the principal user by using a shared password, identification card, or other authentication code, there is no audit trail to show who was actually accessing the system.

### SUMMARY OF THE INVENTION

The present invention provides an authentication mechanism which can allow a delegate to access a networked system on behalf of a principal user without the above-mentioned drawbacks. To this end, and in accordance with the principles of the present invention, both a principal user's authentication code and an authorized delegate's authentication code are associated with the principal user's ID. When a user attempts to log on to the network with a given user ID, the authentication code given by that user may be compared with the principal's stored authentication code for that ID, and if a match is determined, then it is determined that the principal is logging oil and access is given accordingly.

If there is no match, then the delegate's stored authentication code for that principal's ID is evaluated for a match. If there is such a match, then the delegate is given access as if the delegate were the principal user, or may be given partial access to those aspects of the computer or network to which the principal would otherwise have broader access. Alternatively, all stored authorization codes associated with a principal user may be examined, and access given either as the principal or the delegate if a match is found.

As a consequence, when the delegate seeks access on behalf of the principal, in a password-based system, there is no need for the principal to share a password; in an identification card or token-based system, there is no need for the principal to loan a token; and in a biometric-based system, the delegate's own biometric data may be used. Thus, the security problems created by password sharing and identification card and token loaning are reduced or eliminated. Similarly, the inability to allow delegated access in a biometric system is overcome.

In accordance with a further aspect of the present invention, the delegate to a principal may also be a separate principal on the system associated with that delegate's ID for conventional access by the delegate to the delegate's own account.

With the foregoing, it is also possible, if desired, to create a log of delegate access. To this end, if this feature is employed, when a delegate is given access on behalf of a principal user, a log may be created to record that fact. The log may also record data or program access events, lock/unlock events, logout events, and otherwise track the usage by the delegate on behalf of the principal.

By virtue of the foregoing there is thus provided an improved mechanism which can allow a delegate to access a networked system on behalf of a principal user in a manner that addresses above-identified shortcomings of known authentication systems. These and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a block diagram of a networked computer system consistent with the invention;

FIG. 2 is a block diagram of an exemplary hardware and software environment for a computer from the networked computer system of FIG. 1;

FIG. 3 is a flowchart outlining method steps suited for execution within the environments of FIGS. 1 and 2;

FIG. 4 is a dialog box having application within the process steps of FIG. 3; and

FIG. 5 is a flowchart illustrate process steps associated with the login delegation steps of FIG. 3.

### DETAILED DESCRIPTION OF DRAWINGS

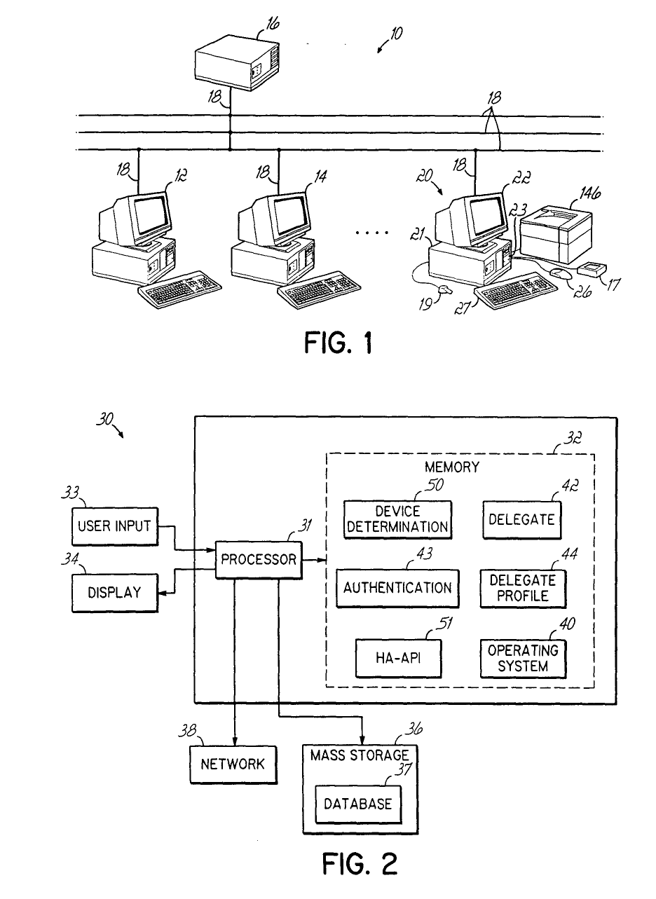

With reference generally to FIG. 1, there is shown a system 10 configured to allow a delegate user to access an account of a principal user in the name of that principal user. More particularly, the exemplary system 10 enables access by the delegate to the principal's account using the capture authentication code of the delegate user. Capture authentication code refers generally to a password, token or biometric signature received at a computer. Preferably, such capture authentication code comprises a biometric identification record (BIR) of the delegate user. However, it should be noted at the onset of this disclosure that the principles of the present invention apply equally to other authentication techniques, to include passwords and authentication tokens.

Generally, the delegate user may use a keypad, mouse, microphone, electronic notepad and/or some other input device to designate a principal user in response to a computer prompt or other interface. The biometric device or other authenticating technique used to verify the identity or otherwise login the delegate may be programmatically determined as product of prior use and network/user preference. Additional considerations may include system and/or hardware mandates and stipulations, The account of the principal user contains data, programs, or other resources to be accessed by the delegate user on behalf of the principal user. Moreover, the delegate may have been approved or granted a privilege to access the account as the principal. To this end, an administrator or the principal may add login information pertaining to the delegate to a profile of the principal. Such information preferably includes stored BIR data, but may alternatively comprise a password or authentication token.

The stored BIR or other authentication code may be recalled in response to the delegate presenting capture BIR data. The capture BIR data prompts the program code to initiate retrieval of the stored BIR data and other information associated with the user from the network or hard drive of the local computer. This provision facilitates login processes by enabling a direct comparison between the stored and capture BIR data. In one embodiment, stored BIR data for each delegate user assigned to the profile of the principal can be recalled in sequential order. Alternatively or in addition, the stored BIR data can be recalled according to its frequency of use or some related chronological scheme. As such, the capture BIR data may be sequentially evaluated against the stored authentication codes, which are recalled for the purpose of finding a match.

If no match can be established after all stored authentication codes have been evaluated against the capture BIR data, then the delegate is denied access to the account of the principal. However, it the capture authentication code correlates to a set of stored BIR data, then the delegate is permitted to enter the account of the principal as the principal user. A log or other record of actions taken by the delegate during the session is maintained for purposes of accountability and system analysis. In this manner, the principal may share data and other resources with the delegate in a secure environment with minimum risk of compromise to password and authentication systems.

These and other exemplary embodiments in accordance with the principles of the present invention are described below in detail. Of note, although a network is shown in FIG. 2 for the purpose of illustrating the functionality of an exemplary application of the invention, other embodiments consistent with the principals of the present invention may suitably include machines isolated from any network connection.

### Hardware and Software Environment

FIG. 1 shows an exemplary computer system 10 suitable for controlling access of privileged delegates to an account of a principal via a computer 20 adapted to communicate with a network 18. As such, computer system 10 is illustrated as a networked system that includes one or more client computers 12, 14 and 20 (e.g., lap top, desktop or PC-based computers, workstations, etc.) coupled to server 16 (e.g., a PC-based server, a minicomputer, a midrange computer, a mainframe computer, etc.) through a network 18. Network 18 represents a networked interconnection, including, but not limited to local-area, wide-area, wireless, and public networks (e.g., the Internet). Moreover, any number of computers and other devices may be networked through network 18, e.g., multiple servers. Significantly, the present invention may have particular application when a computer 12, 14, 20 becomes disconnected from the network 18.

User computer 20, which may be similar to computers 12, 14, may include: a central processing unlit (CPU) 21, a number of peripheral components such as a computer display 22, a storage device 23, a printer 24, and various input devices (e.g., a mouse 26, keyboard 27) to include biometric login devices. Those skilled in the art will recognize that biometric devices compatible with the present invention are not limited to the exemplary devices shown in FIG. 1, which include a fingerprint scanner 17 and microphone 19. Consequently, suitable input devices may comprise any mechanism configured to receive BIR data. For that matter, the principles of the present invention are applicable to all other forms of authenticating data or verifying identities.

Accordingly, suitable input devices to user computer 20 may additionally or alternatively embody one or mores devices configured to receive a password or authenticating token, such as a microchip embedded card or key. Server computer 16 may be similarly configured, albeit typically with greater processing performance and storage capacity as is well known in the art.

FIG. 2 illustrates a hardware and software environment for an apparatus 30 suited to delegate access to electronic data by using an account of a principal in a manner consistent with the principles of the invention. For exemplary purposes and within the context of this disclosure, apparatus 30 may represent a computer, computer system or other programmable electronic device, including: a client computer (e.g., similar to computers 12, 14 and 20 of FIG. 1), a server computer (e.g., similar to server 16 of FIG. 1), a portable computer, a Personal Digital Assistant (PDA), an embedded controller, etc. Apparatus 30 will hereinafter also be referred to as a “computer,” although it should be appreciated the term “apparatus” may also include other suitable programmable electronic devices consistent with the invention.

Computer 30 typically includes at least one processor 31 coupled to a memory 32. Processor 31 may represent one or more processors (e.g., microprocessors), and memory 32 may represent the random access memory (RAM) devices comprising the main storage of computer 30, as well as any supplemental levels of memory, e.g., cache memories, non-volatile or backup memories (e.g., programmable or flash memories), read-only memories, etc. In addition, memory 32 may be considered to include memory storage physically located elsewhere in computer 30, e.g., any cache memory in a processor 31, as well as any storage capacity used as a virtual memory, e.g., as stored within a database 37 or on another computer coupled to computer 30 via network 38.

Computer 30 also may receive a number of inputs and outputs for communicating information externally. For interface with a user, computer 30 typically includes one or more input devices 33 (e.g., a keyboard, a mouse, a trackball, a joystick, a touchpad, smartcard slot, retinal/fingerprint scanner, token detector and/or a microphone, among others) and a display 34 (e.g., a CRT monitor, an LCD display panel, and/or a speaker, among others). It should be appreciated, however, that with some implementations of computer 30, e.g., some server implementations, direct user input and output may not be supported by the computer or system protocol, and interface with the computer may be implemented through a client computer or workstation networked with computer 30.

For additional storage, computer 30 may also include one or more mass storage devices 36 configured to store a biometric database 37. Exemplary devices 36 can include: a floppy or other removable disk drive, a hard disk drive, a direct access storage device (DASD), an optical drive (e.g., a CD drive, a DVD drive, etc.), and/or a tape drive, among others. Furthermore, computer 30 may include an interface with one or more networks 38 (e.g., a LAN, a WAN, a wireless network, and/or the Internet, among others) to permit the communication of information with other computers coupled to the network. It should be appreciated that computer 30 typically includes suitable analog and/or digital interfaces between processor 31 and each of components 32, 33, 34, 36 and 38.

Computer 30 operates under the control of an operating system 40, and executes various computer software applications, components, programs, objects, modules, etc. (e.g., delegate program 42, biometric authentication program 43, delegate profile program 44, Human Authentication Application Programming Interface (HA-API) 51 and authenticating device determination software 50, among others). Of note, HA-API 51 regards an exemplary programming interface supplied by biometric service providers that provides enrollment and verification services for installed biometric devices. Moreover, various applications, components, programs, objects, modules, etc. may also execute on one or more processors in another computer coupled to computer 30 via a network 38, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions will be referred to herein as “computer programs,” or simply “programs.” The computer programs typically comprise one or more instructions that are resident at various times in various computer memory and storage devices. When a program is read and executed by a processor, the program causes the computer to execute steps or elements embodying the various aspects of the invention.

Moreover, while the invention has and hereinafter will be described in the context of fully functioning computers and computer system, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include, but are not limited to recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

### User Delegation

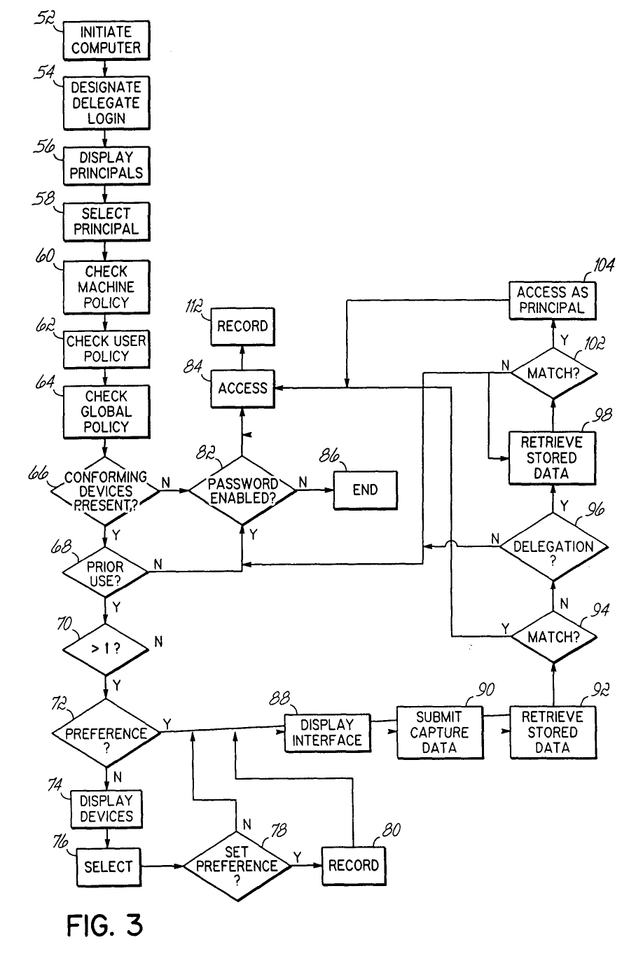

The flowchart of FIG. 3 illustrates an exemplary embodiment for biometrically controlling access of a user with regard to the hardware and software environments of FIGS. 1 and 2. Generally, BIR delegation calls for allowing a delegate user access to electronic data associated with an account of a principal user. More specifically, the delegate accesses the account and associated data as the principal user. Prior to such access, a delegate profile is established for the principal user. A suitable profile may contain a listing of preapproved delegates, or users privileged to enter the account of the principal. Morever, an authentication code correlated to each of the delegates may be stored in a manner accessible to the local computer or networked server running the delegate program 42 of FIG. 2. As discussed below in detail, program code may initiate a comparison of this stored authentication code against the capture authentication code of a user attempting to login as a delegate. The result of the comparison may determine whether or not the user will access the account of the principal.

Turning more particularly to the flowchart of FIG. 3, a user activates or otherwise initiates normal startup processes at a computer terminal at block 52. For instance, the user may boot or turnon the computer while initiating proprietary software resident on the machine. For example, system protocol may require all users to depress a sequence of keyboard symbols to stimulate program execution. In response, the computer may activate programming associated with an applicable operating system and user delegation 43 at block 54. In one embodiment, the program may initially query a server, operating system, or user input to determine if user delegation is available. If so, the program may initiate a display or display option configured to prompt a user to further initiate delegation processes at block 54.

At block 54, a user desiring to login to the account of a principal indicates a wish to do so by initiating programmed instructions configured to guide the user through a delegation login session. For instance, the delegate user may click on a button or check a dialog box labeled “User Delegate Login.” Alternatively or in addition, a system administrator may have previously configured the computer and/or network. Such that the computer software automatically determines that the user delegation feature is enabled at block 52. In either case, the computer accessed by the user recognizes at block 54 of the illustrated embodiment that user delegation has been enabled. Regarding block 54, some computers and networks may not require such initialization processes, and may rather allow the user to proceed directly to block 56. Of note, should user delegation be disabled for the computer at block 54, the conventional login sequence for the computer may be invoked at block 88.

The program code initiates a display of program options at block 56 in response to an action by the user at block 54 indicating a desire to login as a delegate. One such option may include a listing of principal users. That is, a drop-down list of principal users having profiles allowing for delegate users to log into their account on their behalf may be displayed. To this end, the program at block 56 may retrieve at the top of the list of principals, those who have most recently had a delegate access their account in their name. Such a configuration may accommodate those delegates who login with the greatest frequency for an ongoing project. That is, such a setup could save the delegate from having to scroll down a long list of principals. Of note, statistics compiled for this purpose can be measured locally on the machine at which the delegate user attempts to access the account, or they may alternatively reflect overall network use. As such, the computer may display the list of principals in the form of a drop-down screen box. An administrator may set the number of user ID's displayed according to application and performance considerations.

As such, a delegate user may scroll down the drop-down box to select the name of an applicable principal user at block 58. If the name of a principal user sought by the delegate is not displayed by the computer at block 56, the embodiment may present the user with the option of typing the principal's name into a text field. Although not shown in FIG. 3, another embodiment may require the delegate user to provide their own ID subsequent or even prior to selecting the ID of the principal.

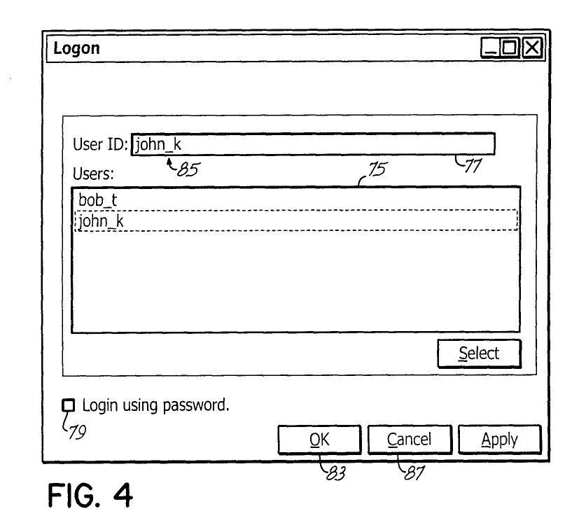

FIG. 4 shows a suitable dialog box having such a text field 77 and drop-down box 75. As shown in FIG. 4, the user may submit the name of the principal 85 by depressing the “OK” button 83. The user may alternatively end a login session by selecting the “Cancel” button 87. In one embodiment, the dialog box may further include a password login option 79. As such, a delegate user may access the account of the principal using the conventional password option so long as allowed by the system administrator. Another embodiment may require users to access the account of a principal using their own conventional password.

One embodiment may programmatically determine which, if any, available devices can be utilized by the user to gain access to the account of the principal. At blocks 60-72, program code determines a set of allowable biometric login devices based on settings relating to the computer, principal user and overarching system mandates. Other considerations can include hardware availability, user preference and prior usage of the authenticating equipment. Thus, steps 60-72 represent one exemplary sequence for triangulating or weighting a biometric login selection process toward system and user preferences. Of note, one embodiment will apply these factors equally to all users attempting to access an account, whether as a delegate or a principal user.

More particularly, the program code may initially access a local BIR policy for the machine at which the user desires to login at block 60. Such a policy may be stored on the local hard drive or may be accessible via the network. Program code at block 60 may evaluate the accessed information to determine if a policy has been established for the accessed computer. A policy may include a preprogrammed preference or mandate for a biometric testing device established by an administrator or a prior user for that machine. Should a connection to the network be established, the computer may similarly query the server for a biometric testing device setting(s).

Of note, should no setting be available at block 60 via the server, the program may substitute a default preference. The default setting, as discussed herein, may track a compilation of available biometric devices on the machine. The policy may further be specific to user delegation applications. Alternatively at block 60, the absence of a setting may cause the program to force the user to provide a conventional password or other non-biometric instrument of authentication.

Similarly at block 62, the BIR policy for the principal user may be evaluated. A user BIR policy may be preset in a database field associated with a relevant account of the principal user. The field or other indicator may mandate one or more devices that are suitable for login with regard to the principal user. Such a setting can act as a default, or statistical preference for a particular user, directing the computer to select a single or ordered group of biometric devices from among the available devices.

Global settings for a network, subsystem and/or group of user accounts can then be queried by the program code at block 64. An administrator, security or account manager can designate groupings of machines or users having particular security requirements. Tags relating to these requirements or settings may be programmatically attached to a database field associated with the designated grouping. Program code at block 64 can then access these fields to obtain security settings applicable to a grouping of machines, users or a system implicated in a delegate login scenario.

At block 66, an accounting is made of which biometric or other authentication devices are currently installed on the computer from which the user seeks to access the account of the principal. For instance, program code may evaluate which biometric devices are installed and available on the local machine at block 66 of FIG. 3. For instance, the local computer of the user may be equipped with both fingerprint and retinal biometric testing devices. Proprietary programs associated with conventional biometric testing devices place a marker within a registry of the computer upon installation and de-installation. This registry provides a mechanism for the embodiment to assess available devices at block 66. In an instance where the computer is communication with the network, the computer may alternatively check the server to obtain status information pertinent to available biometric devices. Should no acceptable or preferred biometric testing device be located on the computer at block 66, an embodiment of the software may, as above, relegate the user to login using a conventional password if the option is available at block 82.

Another factor that can determine which, if any, biometric device will be made available to capture BIR data of the user concerns whether a principal user has previously enrolled using the equipment determined to be available at block 66. Consequently, program code may initiate such a determination at block 68. That is, the computer may determine whether biometric login on an available device has ever taken place oil the computer with regard to the principal user desiring access using the collection of devices available at the terminal. If not, then the user may again be relegated to the password entry of block 82.

Should the computer alternatively determine that the user has previously logged in using a biometric device detected at block 66, then the user delegation program may next determine whether more than one biometric login device is available on the machine at block 70. Of note, should only one biometric device be available and previously accessed, the program may initiate authentication processes directly at block 88. If none of the available equipment has been previously used at block 68, then the user may be relegated to logging in using their password at block 82. Should no such password login procedure be enabled by the an administrator at block 82, then the login session may be ended at block 86. As such, a display may appear on the screen viewed by the user informing them that the login session was unsuccessful and suggesting that they contact a system administrator.

If only one biometric login device candidate remains after the screening processes of blocks 60-68, then biometric processes associated with that device are initiated at block 88. As such, the user may be presented it ill a biometric interface configured to guide the user through a process of submitting a capture BIR. Should the program code alternatively determine that more than one biometric login device is available at block 70, then another database field may be checked to see if a preference for one of the available devices has been designated at block 72. For example, a database field associated with an account of the principal may indicate a mathematical preference for a retinal scanner. As such, a retinal scanner will be a default choice of the programming code in the absence of other input. As discussed below, such a preference may be set during a prior computer session.

If such a preference is indicated at block 72, then the biometric login interface applicable to the preferred login device may be presented directly to the user at block 88. That is, should the program detect a preferred setting at block 72 that corresponds to a conforming BIR capture device, then it may initiate testing sequences associated with the preferred biometric device at block 88.

Should no single, biometric testing preference be recorded for the user at block 72, then one embodiment may prompt the user to select a biometric testing sequence at block 76 from a listing displayed at the terminal at block 74. More specifically, program code may initiate the display at block 74 of a listing of those previously-used biometric devices available on the local machine that conform to the user, machine and global settings prescribed in blocks 60-68. As such, the user may select one or more biometric verification processes by typing in or clicking on a device displayed at block 74.

In addition to selecting a login device, the user may also set a preference for later sessions at block 78. For instance, a user may stipulate a preference for logging in using a fingerprint scanner. Should such a preference be designated at block 78, then that fingerprint scanner preference will be recorded at block 80. As such, the program code can recall the preference at block 72 of a subsequent session. Alternatively, the user may not wish to set a preference at block 78, or an administrator may disable such an option, altogether. In either case, a software interface particular to the biometric login device selected at block 76 presents itself to the user at block 88.

Program code may retrieve software associated with the designated biometric in preparation of the biometric challenge at block 88. The program then launches the designated/preferred biometric test according to the preset parameters of the biometric verification sequence. That is, should the preferred biometric testing device be thus available and approved, the user may be prompted to provide appropriate capture BIR data at block 88. More particularly, the program may initiate and display a user interface screen configured to cause the user to provide the preferred and appropriate biometric testing data. For instance, a fingerprint authentication application may prompt the user, “Please place finger on pad.”

At block 90, the user may provide the appropriate capture BIR data. The computer, in turn, collects the capture BIR data according to the known biometric login sequence appropriate to the preferred testing device. That is, the user submits a capture BIR according to the applicable BIR mechanism and software at block 90. As discussed herein, devices suited to receive such data can include a fingerprint or retinal scanner, DNA sampler, camera, radiation detector, microphone and any other known biometric collection device. Morever, while the embodiment discussed in conjunction with FIG. 3 basically concerns biometric logins, another embodiment may utilize a non-biometric authenticating procedure such as tokens or passwords.

In response to collecting the capture BIR data at block 90, the software may recall at block 92 a set of stored BIR data correlated to the principal user. Because in the present scenario the user is attempting to login as a delegate, the stored BIR data will not match the capture BIR data at block 94. However, program code consistent with the principles of the present invention may nonetheless allow for such a comparison to accommodate instances where the principal desires to conventionally log into their own account. Thus, the embodiment is consistent with and accommodates known login authenticating systems, techniques and practices. As such, the principal can access their own account at block 84 in accordance with conventional login sequences.

In response to an unsuccessful match at block 94, program code will check a database field associated with the principal to see if the profile of the principal is configured for delegated login at block 96. Such a designation may have been accomplished back at block 54. If not, then the user may be directed to attempt a login sequence at block 82 using their conventional password. Should such an access mechanism be unavailable to the user at block 82, then the session may be ended in a manner analogous to that described above in connection with block 86.

If the account profile of the principal user has been set up for delegated login, then the program code may retrieve stored BIR data correlated to a first delegate at block 98. As discussed below in greater detail, the delegate is a user privileged by the principal or a system administrator to access the account of the principal as the principal user. The delegate can in this manner perform duties and review data in the name of and with the full or partial permissions the principal.

For efficiency purposes, the first delegate evaluated by the program code may be the delegate who most frequently accesses the account of the principal. As such, the program code may attempt to verify the capture BIR data using a retrieved history of recent logins. That is, the program may begin evaluating the stored authentication code in chronological order beginning with the most recent delegated user to access the account of the principal. As such, the program may sequentially evaluate stored BIR data until a numerical match is detected. Another embodiment in accordance with the invention may select stored BIR data of the delegate user to login based oil the explicit delegate user ID entered in block 54, or of one who is programmatically designated to be retrieved first for efficiency or protocol purposes.

The stored BIR data of the first delegate is compared against the capture BIR data at block 102. Should the match be unsuccessful, then the program code may retrieve stored BIR data correlated to another delegate user included within the profile of the principal user at block 98. As contemplated in this disclosure, this second set of stored BIR data could relate to a delegate user who statistically accesses the account of the principal with the second most frequency. In consideration of memory and processing time, one embodiment may limit the delegate users for which authentication code is recalled to around five to ten. However, an administrator may increase or decrease the volume of BIR data stored/retrieved according to application requirements and CPU resource availability.

The processes of blocks 98-102 may repeat as necessary until it has either sequenced through the stored BIR data of all potential delegate users or a match is realized at block 102. Should the verification process be unsuccessful at block 102, one embodiment of the program code may relegate the user to any available password login procedures back at block 82, or the login session may end altogether at block 86. Another embodiment may send the user back to block 76 to select from the same or other available biometric login devices. Of note, the respective login protocol may allow for multiple authentication attempts at block 102 before ending a session.

Alternatively, should a match be realized at block 102, then the delegate user is granted access to the account of the principal at block 84 as the principal. That is, the delegate user gains access upon matching and evaluation processes of block 102 numerically or otherwise establishing that the accessing user is the delegate user associated with the stored BIR data. In response to a match, an embodiment of the program code may transparently recall and present any ID or password information associated with the matched BIR that is required by an operating system. This feature fulfills vendor and system requirements while liberating an accessing user from password/ID redundancies.

In any case, information pertaining to actions taken by the successful delegate user can be recorded within a log or other memory for analysis and accountability purposes. For instance, the times associated with the login and logout of the accessing delegate user may be recorded within the log at block 112, along with information relating to locking and unlocking a computer screen, as well as launching protected application programs.

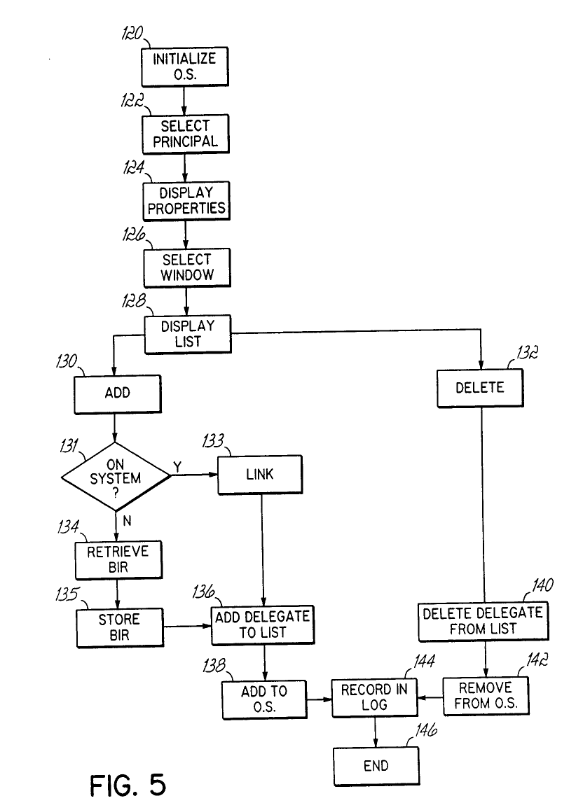

The flowchart of FIG. 5 includes processes suited to establish and/or update a profile of a principal utilized by the processes of the user delegation embodiment stepped out in FIG. 3 to determine delegate privileges. As discussed above, such a profile may be stored in association with a principal user within local or network memory and may include a listing of delegate users privileged to access their account as the principal user. The profile can additionally contain links or memory structure configured to recall stored BIR data correlated to the delegate users.

Generally, the sequenced steps outlined in FIG. 5 represent an exemplary session for adding or deleting delegates to a profile of a principal user in a manner that is in accordance with the principles of the present invention. At block 120, an administrator, a principal or other authorized individual may initialize system processes. For instance, the individual may activate or otherwise initiate normal startup sequences to include rebooting or turning on the computer. Software resident on the machine or network configured to update a profile of a principal may be initiated, accordingly.

At block 122, the user may select a programmatic object or other memory structure associated with the principal by designating a link, field, or subroutine configured to call up properties and other information concerning an account of the principal. For instance, the user may click on an applicable button or text with a computer mouse. In response, program code may display properties of the account to the user at block 124. From among these account properties, the user may select a tab or field labeled, “Delegate Window” at block 126. In response, program code may initiate a display of all delegate users privileged to access the account of the principal at block 128 The display may comprise a drop-down list of names or other descriptors designating individual or groups of users. For instance, a grouping of delegates assigned to an account may comprise participants in a project development team.

The principal, administrator, or other authorized user may add a delegate user to the account of the principal at block 130. Assuming all administrative permissions and any required background checks have been accomplished, program code may evaluate at block 131 whether the intended delegate is already registered on the operating system or network. If so, the user may merely link to and/or download identifying information that has previously been stored onto the network and that pertains to the delegate. Such identifying information retrieved at block 133 preferably includes a stored BIR in addition to other login data. This feature promotes efficient and safe avenues of data and resource sharing by capitalizing on preexisting data and links inherent to the system.

Where permissible, the administrator or other authorized user can alternatively enroll the delegate in the system at block 134 and 135. For instance, the user may cause enrollment BIR data of the delegate to be captured or downloaded at block 134. This enrollment can be stored at block 135 for later use in verifying the identity of the delegate as a user authorized to access the account of the principal. Of note, it may not be desirable or compatible with system security requirements for the delegate to be enrolled within the context of FIG. 5. Consequently, another embodiment may supplant the functionality of steps 134 and 135 with an error message to the user that effectively ends the session and instructs them to consult system regulations or management/administrative personnel to first register as a user on the operating system or network so the evaluation at block 131 will succeed.

Should the BIR data correlating to the delegate be available via either of blocks 133 or 135, then the name, ID or other designator of the delegate can be added to the domain listing of delegates displayed in conjunction with the profile of the principal. Accordingly, permissions associated with the applicable operating systems are transparently aligned at block 138 to enable the added delegate access to the account of the principal.

Conversely, the user may remove a delegate from a principal's profile as required by personnel and project status developments at block 132. As such, an administrator may click or otherwise select a listed identifier correlated to the delegate user and displayed within the delegate window. Thus selected, the administrator may click on button that deletes the name of the former delegate user from the profile listing at block 140. Links and other information pertaining to the former delegate are accordingly removed from the operating system, account, processor, memory and/or other resources of the principal user at block 142. As such, the former delegate user can no longer access the account of the principal using delegation processes. In this manner, the profile of the principal user may be updated to remain current with project and system security requirements. As above, any action taken with regard to the properties of the principal's account, including adding and deleting delegate users, is recorded at block 144 prior to the session ending, at block 146.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. For example, a program of the invention may encrypt biometric data, conventional passwords and other information at any step delineated in the flowcharts of FIGS. 3 and 5. Morever, the sequence of the steps in the flowcharts of FIGS. 3 and 5 could be altered, to include omitting certain processes without conflicting with the principles of the present invention. Morever, related or known processes can be incorporated to complement those discussed herein. For example, a delegate user could proffer their identity to the operating system prior to logging in as a delegate. As such, the user could select their user ID from a drop-down list affiliated with the principal. Program code could initiate the immediate retrieval of stored BIR data associated with the submitted user ID for comparison against the capture BIR data as above. Should a match be determined, then the user would login to the account of the principal as a delegate. Such a configuration could save processing cycles spent in cycling through stored BIR data of all eligible delegates assigned to a principal.

Furthermore, one skilled in the art should appreciate that any of the embodiments and associated programs discussed above are compatible with all known authenticating processes and may further be optimized to realize even greater efficiencies. For instance, a program that locally stores BIR data in response to a successful login may be complimented by the present invention. Such a program may cause an accessing user to provide capture BIR data to a local computer when accessing a network server. One embodiment of the present invention may retrieve and locally store the enrollment BIR data of a delegate user at the computer from the server following a successful login as the principal by the delegate user. Such enrollment data may have application for facilitating remote and accelerated user access. The general process of locally storing biometric data in response to a successful login is disclosed in International Application No. PCT/US01/30458, which was filed on Sep. 28, 2001, is entitled “Biometric Record Caching,” and is hereby incorporated by reference in its entirety.

Another embodiment consistent with the principles of the present invention allows a delegate user to biometrically access a computer on behalf of a principal user without first providing another source of identification. As above, that general concept was first disclosed in International Application No. PCT/US01/30458, which was filed on Sep. 28, 2001, is entitled “Biometric Record Caching,” and is hereby incorporated by reference in its entirety. Within the context of the present invention, a delegate user's first interaction with a machine may comprise the placement of an index finger onto a scanner in communication with the computer. Similarly, a microphone coupled to the computer may recognize the voice pattern of the accessing user without first requiring identification information. Program software running on the computer compares capture BIR data to stored enrollment BIR data and determines if a match is present. In the event of such a match, the program may retrieve and configure an ID and password associated with the enrollment BIR data to verify privileged access status to the account of the principal.

Morever, while one embodiment described herein concerns a networked operation, one skilled in the art will appreciate the principles of the present invention apply equally to stand-alone computers as well. The invention in its broader aspects is, therefore, not limited to the specific details, representative apparatus and method, and illustrative examples shown and described. Accordingly, departures may be made from such details without departing from the spirit or scope of the general inventive concept.

Having described the invention, what is claimed is:

1. A method of controlling access to electronic data, comprising:
receiving capture authentication code from a user desiring access to an account of a principal user;
determining if the capture authentication code received from the user matches within predetermined parameters a set of stored authentication code correlated to the principal user;
if there is such a match of the capture authentication code, permitting the user access to the account of the principal user; and
if the match is not established, determining if the capture authentication code received from the user matches within predetermined parameters a set of authentication code correlated to a delegate user privileged to access the account of the principal user.

2. The method of claim 1, further comprising denying the user access to the account of the principal user in response to the capture authentication code not matching within the predetermined parameters the set of authentication code correlated to the delegate user.

3. The method of claim 1, further comprising granting the user access to at least a portion of the account of the principal user on behalf of the principal user in response to the capture authentication code matching within the predetermined parameters the set of authentication code correlated to the delegate user.

4. The method of claim 3, wherein granting the user access to the account further includes granting the user restricted access to the account.

5. The method of claim 3, further comprising storing information within a memory for later use, the information pertaining to an action made by the user while operating within the account of the principal user.

6. The method of claim 5, wherein the action is selected from among a group consisting of at least one of: logging in, logging out, locking a computer, unlocking the computer, launching protected application programs, viewing data and inputting data.

7. The method of claim 1, wherein determining if the capture authentication code received from the user matches the set of authentication code correlated to the delegate user privileged to access the account of the principal user as the principal user further includes retrieving the set of authentication code from a remote network server.

8. The method of claim 1, further comprising locally storing the set of authentication code correlated to the delegate for future use in response to the capture authentication code received from the user matching within predetermined parameters the set of authentication code correlated to the delegate user privileged to access the account of the principal user as the principal user.

9. The method of claim 1, further comprising encrypting the set of authentication code correlated to the delegate.

10. The method of claim 1, further comprising recalling a profile associated with the principal user.

11. The method of claim 10, further comprising assigning identifying information associated with the user to the profile.

12. The method of claim 10, further comprising deleting identifying information associated with the user from the profile.

13. The method of claim 1, wherein receiving authentication code further includes selecting a biometric device used to enter the capture authentication code based upon selection criteria wherein the selection criteria relates to considerations selected from a group consisting of at least one of: a user preference, a user privilege, a default machine setting, a default network setting, prior usage, an administrative command, system processing time, and device and system availability.

14. The method of claim 1, wherein determining if the capture authentication code received from the user matches within predetermined parameters the set of authentication code correlated to the delegate user further includes retrieving a recently used set of authentication code.

15. The method of claim 1, further comprising receiving a first user ID associated with a first user selected from a group consisting of at least one of: the principal user and the delegate user.

16. The method of claim 15, further comprising receiving a second user ID associated with a second user selected from a group consisting of at least one of: the principal user and the delegate user.

17. A method of selecting a BIR capture device to receive capture BIR data from a user from among a plurality of BIR capture devices, comprising:
programmatically determining a first BIR capture device of the plurality of BIR capture devices from a user setting established for the user, wherein the user setting indicates a partiality to at least the first BIR capture device;
programmatically determining a second BIR capture device of the plurality of BIR capture devices from a machine setting particular to a computer, wherein the machine setting indicates a partiality to at least the second BIR capture device;
programmatically determining a third BIR capture device of the plurality of BIR capture devices from a global setting designating a preference for at least the third BIR capture device; and
if the first, second and third BIR capture devices correspond to at least one BIR capture device that conforms to the user, machine and global settings, receiving capture authentication code from the at least one BIR capture device.

18. A method of controlling access to electronic data, comprising:
receiving capture authentication code from a user desiring access to an account of a principal user;
determining if the capture authentication code received from the user matches a set of stored authentication code correlated to a group consisting of at least one of: a principal user and a delegate user;
if there is such a match of the capture authentication code, permitting the user access to at least a portion of the account of the principal user on behalf of the principal user.

19. The method of claim 18, further comprising denying the user access to the account of the principal user in response to the capture authentication code not matching within the predetermined parameters a set of stored authentication code correlated to a group consisting of at least one of: the principal user and the delegate user.

20. The method of claim 18, wherein permitting the user access to the account of the principal user as the principal user further includes recording an identifier communicative of an identity of the user.

21. The method of claim 18, wherein permitting the user access to the account of the principal user as the principal user further includes storing information within a memory for later use, the information pertaining to an action made by the user while operating within the account of the principal user.

22. The method of claim 18, wherein determining if the capture authentication code received from the user matches a set of stored authentication code correlated to a group consisting of at least one of: a principal user and a delegate user, further includes retrieving a recently used set of authentication code.

23. An apparatus, comprising:
a memory;
a database resident within the memory, the database storing respective sets of authentication codes, a first set of authentication code correlated to a principal user and a set correlated to a delegate user having privileged access to an account of the principal user;
program code configured to receive capture authentication code from a user desiring access to the account of the principal user and to determine if the capture authentication code received from the user matches within predetermined parameters the set of stored authentication code correlated to the principal user; if there is such a match of the capture authentication code, the program code further permitting the user access to the account of the principal user; and if the match is not established, the program code being configured to determine if the capture authentication code received from the user matches within predetermined parameters the set of authentication code correlated to the delegate user privileged to access the account of the principal user as the principal user.

24. The apparatus according to claim 23, wherein the program code initiates denying the user access to the account of the principal user in response to the capture authentication code not matching within the predetermined parameters the set of authentication code correlated to the delegate user.

25. The apparatus according to claim 23, wherein the program code initiates granting the user access to the account of the principal user as the principal user in response to the capture authentication code matching within the predetermined parameters the set of authentication code correlated to the delegate user.

26. The apparatus according to claim 25 wherein the program code initiates granting the user access to the account further includes granting the user restricted access to the account.

27. The apparatus according to claim 25, wherein the program code initiates storing information within a memory for later use, the information pertaining to an action made by the user while operating within the account of the principal user.

28. The apparatus according to claim 27, wherein the action is selected from among a group consisting of at least one of: logging in, login out, locking a computer, unlocking the computer, launching protected application programs, viewing data and inputting data.

29. The apparatus according to claim 23, wherein the program code initiates retrieving the set of authentication code correlated to the delegate user privileged to access the account of the principal user from a remote network server.

30. The apparatus according to claim 23, wherein the program code initiates locally storing the set of authentication code correlated to the delegate for future use in response to the capture authentication code received from the user matching within predetermined parameters the set of authentication code correlated to the delegate user privileged to access the account of the principal user as the principal user.

31. The apparatus according to claim 23, wherein the program code initiates encrypting the set of authentication code correlated to the delegate.

32. The apparatus according to claim 23, wherein the program code initiates recalling a profile associated with the principal user.

33. The apparatus according to claim 32, wherein the program code initiates assigning identifying information associated with the user to the profile.

34. The apparatus according to claim 32, wherein the program code initiates deleting identifying information associated with the user from the profile.

35. The apparatus according to claim 23, wherein the program code initiates selecting a biometric device used to enter the capture authentication code based upon selection criteria, wherein the selection criteria relates to considerations selected from a group consisting of at least one of: a user preference, a user privilege, a default machine setting, a default network setting, prior usage, an administrative command, device and system availability and system processing time.

36. The apparatus of claim 23, wherein the delegate user has independent access to a system supporting the account.

37. A program product, comprising:
a program configured to receive capture authentication code from a user desiring access to the account of a principal user and to determine if the capture authentication code received from the user matches within predetermined parameters a set of stored authentication code correlated to the principal user; if there is such a match of the capture authentication code, the program code further permitting the user access to the account of the principal user; and if the match is not established, the program code being configured to determine if the capture authentication code received from the user matches within predetermined parameters a set of authentication code correlated to a delegate user privileged to access the account of the principal user as the principal user; and
a signal bearing medium bearing the first program.

38. The program product of claim 36, wherein the signal bearing medium includes at least one of a recordable medium and a transmission-type medium.
